(19) United States
(12) Patent Application Publication
(10) Pub. No.: US 2017/0215388 A1
(43) Pub. Date: Aug. 3, 2017

(54) SYSTEM AND METHOD FOR MONITORING AND ANALYZING ANIMAL PHYSIOLOGICAL AND PERFORMANCE SIGNALS

(71) Applicant: Mathieu Delecroix, (US)

(72) Inventor: Mathieu Delecroix, New York, NY (US)

(21) Appl. No.: 15/011,597

(22) Filed: Jan. 31, 2016

(51) Int. Cl. A01K 29/00

(52) U.S. Cl. CPC A01K 29/005

(57) ABSTRACT

A system and method for monitoring and reporting the performance of an animal under training is disclosed. A centralized hub may be provided for coordinating and aggregating data from a plurality of sensors attached to an animal. A mobile computing device in communication with a centralized hub may further gather data and transmit the data to a remote server where reporting and analytics may be performed.

### BACKGROUND

The present invention relates to a monitoring system and a method for recording and analyzing performance data from an animal under training or racing conditions using a plurality of sensors connected to a centralized hub and mobile computing device.

### BRIEF DESCRIPTION OF THE DRAWINGS

The features and advantages of the present disclosure will be more fully understood with reference to the following detailed description when taken in conjunction with the accompanying figures, wherein:

FIG. 1 is a high-level functional block diagram of an exemplary embodiment of the present invention.

FIG. 2 shows an exemplary a system according to embodiments of the invention;

FIG. 3 is a functional block diagram of the key components of an exemplary centralized hub according to embodiment of the present invention;

FIG. 4 is a flowchart describing a usage scenario of an exemplary embodiment.

### SUMMARY

In some embodiments, a system for collecting data related to the physiology and performance of an animal may include a group of sensors in contact with the animal and/or a hub in communication with the group of sensors.

In some embodiments, the hub is configured to communicate data from the group of sensors to a local communication device. In some embodiments, the data is stored and analyzed on the local communication device or sent to a remote server for analysis. In some embodiments, the hub may include wireless transceiver, enclosure, processor, memory, and battery. In some embodiments, the hub may further include a unique identifier. In some embodiments, the hub is wirelessly connected to the local communication device and at least one of the sensors. In some embodiments, the hub is encased in a protective enclosure that renders it substantially impervious to dirt and moisture.

In some embodiments, the group of sensors measure at least one of heart rate, speed, and respiratory rate.

In some embodiments, the local communication device is a smartphone. In some embodiments, the local communication device capable of performing real-time analysis and reporting of data.

In some embodiments, at least one of the group of sensors are affixed to the skin of the animal. In some embodiments, at least one of the group of sensors are attached to the animal using a horsebit. In some embodiments, at least one of the group of sensors are inserted into the ear canal of the animal.

In some embodiments, such a system may further include application software loaded on the local communication device that enables the local communication device to pair with the hub, receive the data, and perform analytics on the data.

### DETAILED DESCRIPTION

A system and method for monitoring and analyzing animal physiological and performance signals will now be described. In exemplary embodiments, the system of the present invention comprises a centralized hub for aggregating data signals from a plurality of sensors configured to monitor the physiology and performance of an animal such as a horse, dog or livestock. Sensors attached by wired connection to the animal may provide data to the centralized hub that in turn transmits the data to a local communication device. Data arriving at the local communication device may be analyzed in situ or may be further transmitted to a remote server for more advanced analytics and reporting, storage, or purposes.

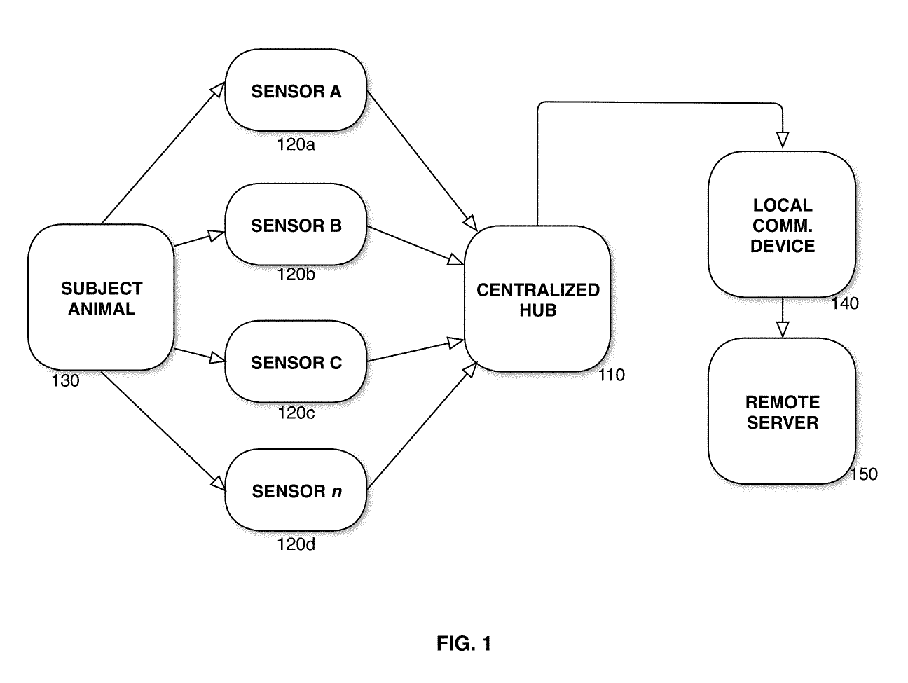

Referring to FIG. 1, a high-level functional block diagram of an exemplary embodiment of the present invention is shown. Centralized hub 110 may be connected to a plurality of sensors 120a, 120b, 120c . . . 120n via a wired or wireless connection. Sensors 120a, 120b, 120c, . . . 120n may be attached to an animal 130 and provide data such as heart rate, speed, respiration, and so forth. Data from these sensors may be transmitted via the wired or wireless connections to centralized hub 110 as a centralized point to aggregate incoming data. As data is collected by centralized hub 110, it may be transmitted to local communication device 140, which may be a smartphone, tablet, smart watch, or other mobile computing device. Local communication device may enable computation and preliminary analysis of data and report it on the device itself (if a display option is available) or may transmit the data to a remote server 150 for further analysis and processing. The local communication device may also have capabilities for sending the data and preliminary analysis to Bluetooth enabled devices like headset, watch or glasses to the users for real-time monitoring.

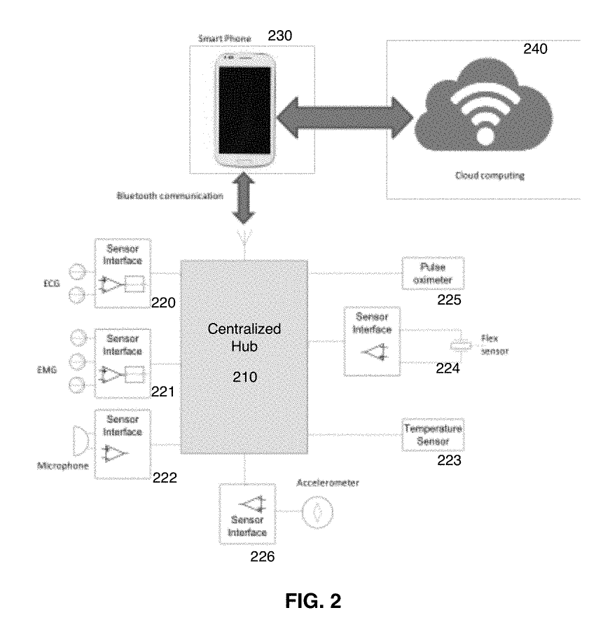

Referring to FIG. 2, a system according to exemplary embodiments of the invention is shown. A centralized hub 210 may be provided for collecting signals from remote sensors and coordinating communication with other data storage and analysis components in the system. In embodiments, centralized hub 210 may be a computing device that is resistant to environmental factors such as weather, vibration, and the like. In embodiments, centralized centralized hub 210 may be housed in a protective enclosure that is substantially impervious to environmental or weather conditions that could damage or impair the electronics inside.

In embodiments, centralized hub may be encased in a shell formed from a polymer such as polycarbonate or polyurethane; silicone; acrylic; or similar. In embodiments, centralized hub 210 may have a sleek form factor—roughly the size of a deck of playing cards—so that the operator may discreetly store the device without interfering with training activity.

The centralized hub may be paired using a wireless connection to a local communicating device 230 which is controlled by the user. The local communication device is capable of performing more complex analysis and computation (depending on the processor and operating system on the device) and can provide a real-time feedback to the user. It may be further capable of logging sensor data into a local storage and transferring the data to a cloud-computing platform if network transmission channels such as 4G/3G or Wi-Fi connection is available, either automatically or at user's request.

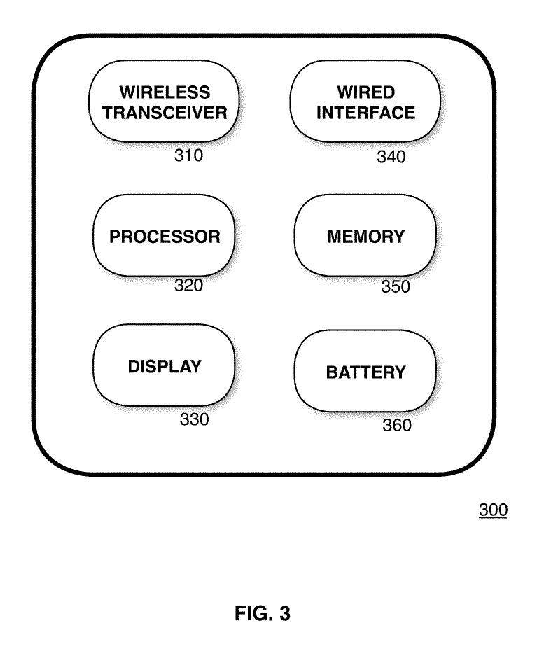

Referring to FIG. 3, a functional block diagram of the key components of an exemplary centralized hub 300 is shown. In embodiments, centralized hub may comprise a wireless transceiver 310 for communicating with the array of remote sensors attached to the animal, and for communicating with a remote computing device. While a Bluetooth transceiver is preferred, in embodiments other types of wireless connections may be employed such as Wi-Fi, RF, infrared, microwave, and others to provide a link from sensors to centralized hub, and on to a mobile communication device. Depending on the application, a wired connection may be substituted for the wireless connection between centralized hub and the sensors and/or the mobile computing device.

Any Bluetooth transceiver capable of pairing with conventional Bluetooth devices may be employed. For example, a Bluetooth low energy device may be used to extend the battery life of the centralized hub. The Bluetooth transceiver may be a part of the centralized hub which is paired with a local communicating device. The centralized hub may collect analog data from the sensors and convert it to digital values and sends it to the Bluetooth enabled local communicating device. One such example is the HM-10 CC2540 4.0 BLE Bluetooth to UART Transceiver Module by Huamao Technology Co., Ltd.

In embodiments, a processor 320 may be provided for coordinating the various components of centralized hub 300, establishing connections, routing data to memory, and so forth. Processors found to work with the present invention include 16- or 32-bit microcontrollers from Texas Instruments or Atmel. The processor controls the sensor arrays and other components of the centralized hub. The processor may initiate the sensor measurements at a predefined sampling rate in an orderly fashion (recursive sensor 1, then Sensor 2, then Sensor n, then Sensor 1 etc.) and stores it in a local memory (350). Once a cycle of sensor measurement is completed, it is transmitted via wire or wirelessly to the local communicating device. In embodiments, the processor itself may have a 12-bit analog to digital converter (ADC) with 8 input channels. The processor also prepares the data packet to be transmitted wirelessly. Various 16- or 32-bit RISC microcontrollers from Texas Instruments or Atmel have been found to work for this purpose. A memory 350 may also be provided and may be connected to processor 320. Data is received from the sensor array may be temporarily stored in memory 350 before further transmission or processing.

In embodiments, centralized hub may be associated with a unique identifier 330 so that particular centralized hubs may be associated with particular animals. For example, in an environment where horses are trained it may be desirable for each horse to have its own centralized hub with a unique identifier so that data may be easily aggregated over time. In such an embodiment, the hub is used for only one animal and all data coming from that hub will be associated with that particular animal. Alternatively, an operator may associate a particular hub with a particular animal for a single session and make adjustments in the mobile application software described below.

A unique identifier may be implemented or embedded in a variety of ways such as being stored in the system's ROM or firmware (similar to a MAC address), RFID, Bluetooth address (BD_ADDR), or similar.

As discussed above, a wired interface 340 may also be provided for connecting to sensors by hard wire where environmental factors, or the specifications of the sensor, require a wired connection. The type of wired interface may vary by application, but exemplary connections may include a 3.5 mm headphone/microphone port, USB interface, serial port, or the like.

In embodiments, a memory 350 may be provided for storing data received from a sensor array. In exemplary embodiments, a 2 GB SD card with serial and random access capability has been utilized. A serial interface with the processor can be used for fast and reliable data storage and transmission.

Lastly, a battery 360 may be provided for powering the components of centralized hub 300. Battery 360 is preferably a NiMH rechargeable cell that may be recharged through, for example, an external USB connection. Battery 360 may also consist of other types of rechargeable batteries or even disposable alkaline batteries.

In embodiments, a protective cover may be provided to cover any external ports on the device when not in use. For example, a silicone plug may be provided to insert into the battery charging terminal for when the device is not charging. Moisture, dirt, and other problematic components may thus be kept form interfering with the device.

Referring back to FIG. 2, centralized hub 210 may be connected to a mobile computing device that is configured to receive sensor data from centralized hub 210 and provide an interface to the user.

In embodiments, mobile computing device 230 may be a conventional smartphone with an embedded wireless transceiver, a tablet computing device, smart watch or any other device capable of wirelessly receiving and storing data from the centralized hub.

In embodiments, mobile computing device 230 may comprise a global positioning system that provides location information to the system. Mobile computing device may also provide time of day, and any other sensor data built in to the device. For example, an iPhone 6S incorporates a GPS sensor, along with compass, accelerometer, barometer, and other devices, data form that may be integrated into the feed from the sensor array to enhance the richness of the data collected.

In embodiments, sensors embedded in the mobile computing device may alert the system to changes. For example, a GPS sensor in the mobile computing device may provide location data that may be used to determine the user and animal speed and motion. The system could then be directed to shut off without further user intervention should speed fall below a certain threshold that could be defined by the operator. Using the same GPS sensor, the system could be directed to commence recording data without immediate intervention of the user.

### Sensor Array

In embodiments of the present invention, an array of sensors may be provided to gather data on the health and performance of an animal. Referring to FIGS. 2 and 3, various sensors for collecting data are shown. The specific type of sensor(s) utilized with the system will vary depending on the type of animal, application, environmental conditions, and other factors. The specific description of any sensor below is meant to be exemplary and not limiting.

In a preferred embodiment, an electrocardiogram (“ECG”) sensor 220 may be utilized to gather data on the electrical functions of the heart. The ECG sensor may provide information on the heart rate of the animal, the rhythm or irregularities in the frequency of the animal's heartbeat, whether the heart has sustained any damage, and other information. In embodiments, ECG may be a sensor mounted in the ear canal of the animal where it has been found that electrode displacement is limited during animal motion, which attenuates noise signal during recording. In the case of an equidae, the ECG sensor may be affixed to the horsebit configured to receive data by contact with the tongue, which has shown to be an effective due to the concentration of blood in the tongue of certain animals, and because moisture on the tongue provides an effective electrical contact.

In embodiments, an electromyography (“EMG”) sensor 221 may be provided to provide data on the health of muscles to help identify muscular or neurological abnormalities of the animal. The EMG sensor may be attached to the animal using electrodes that are affixed to the skin. It may be more convenient to use dry electrodes rather than wet electrodes for EMG measurement as the hair on the animal does not need be removed before the measurement. Further, having the signal conditioning system on the electrode will help to reduce the signal attenuation and interference due to motion that might come from the connection cable to the hub. It has been found that systems such as the Bitalino EMG sensing system are well-suited for the system of the present invention.

In embodiments, a pulse pulse oximeter 225 may be provided for measuring blood oxygenation/O₂ saturation in blood, as well as for detecting cardiac or respiratory issues in the animal. In embodiments, pulse oximeter 225 may be affixed to the inner side of the animal's ear or mounted inside the ear canal of the animal where is has been found that the concentration of blood vessels in that region provide a good sensor reading with low external interference. In the case of equidae, the pulse oximeter 225 may also be affixed to the horsebit and configured to receive data by contact with the tongue, which has shown to be an effective due to the higher concentration of blood in the tongue of certain animals. Pulse oximeter 225 may be of the transmissive or reflectance variety. It has been found that the SENSORPRO-SPO2 developed by Plux Wireless biosignals s.a. (Portugal) is capable of measuring accurately heart rate and the oxygen saturation level of the blood in a highly wearable form factor. However, any sensor that is minimally invasive to the animal and portable may suffice.

In embodiments, a flex sensor 224 may be provided to measure the angle of the stride of an animal. As with all sensors, flex sensors may be attached to centralized hub by wired or wireless connection. Flex sensor 224 may take the form of a variable printed resistor incorporating resistive carbon elements on a thin substrate that can be attached to the animal. When the animal's stride causes a bend in the substrate of the flex sensor 224, the sensor provides a resistance that correlates to the bend sensor, from which the change in angle may be deduced. The angle of the sensor may provide information about the position of the animal's leg(s) relative to a prior reading and thus provide information about the stride and gait.

In embodiments, flex sensor 224 may also provide information about the pitch of the horse, particularly flexion and extension at the croup (in the case of a horse, for example), and the slope of the horse's sacrum. Such a measurement may provide valuable information on the posture of the animal. Flex sensor 224 may provide information not only on stride and gait, but also tendon and muscle strain.

It has been found that the FlexSensor manufactured by SpectraSymbol of Salt Lake City, Utah is effective for applications of the present invention. However, any sensor that is minimally invasive to the animal and portable may suffice.

In embodiments a thermometer may be provided to measure the body temperature of the animal. Type type of temperature—e.g., skin surface temperature, body temperature, etc.—may vary by application and will depend on the animal being analyzed. The temperature of the animal may be utilized in evaluating whether an increased risk for heat exhaustion is present compared to the air temperature may provide information about whether there is an increased risk of heat exhaustion, hypothermia, or simply for monitoring the overall health of the animal. In embodiments, the temperature may also be recorded continuously at night to analyze the circadian rhythm of the animal. In embodiments, thermometer may be a sensor mounted in the ear canal of the animal or affixed to the collar or the harness of the animal.

In embodiments, one or more accelerometer(s) may be incorporated to measure the acceleration of the animal during, for example, training. The accelerometer 226 may be mounted as a discrete component connected—wirelessly or by wire—to the centralized hub, or may be integrated entirely within the centralized hub. Accelerometer 226 may provide information concerning the rate of acceleration of the animal, which may be valuable in training, and may also provide information on the direction of the animal. Irregularities in spatial recording can also provide information about asymmetry in stride and gait and therefore potential injury or malformation.

In embodiments, a microphone 222 may be integrated into the system to detect respiratory patterns in the animal. In embodiments, microphone 222 may be positioned in the ear canal of the animal where it has been discovered that the sounds of respiratory activity may be readily detected. An earplug located upstream of the microphone in the ear canal provides a natural attenuation to external noise, therefore improving considerably the quality of the respiratory sounds recording.

In embodiments, a saliva-based sensor may be utilized to measure lactic acid production in the animal. Lactic acid may be produced during times of intense exercise and in particular, when blood oxygen is low. It has been found that a correlation exists between saliva lactate and blood lactate and that measurement of saliva lactate may act as a proxy for blood lactate. In the case of a horse, one or more electrodes may be mounted on the horsebit, which is a metal or synthetic bar that is placed in the mouth of the animal to enable the operator to communicate with the animal.

### System Operation

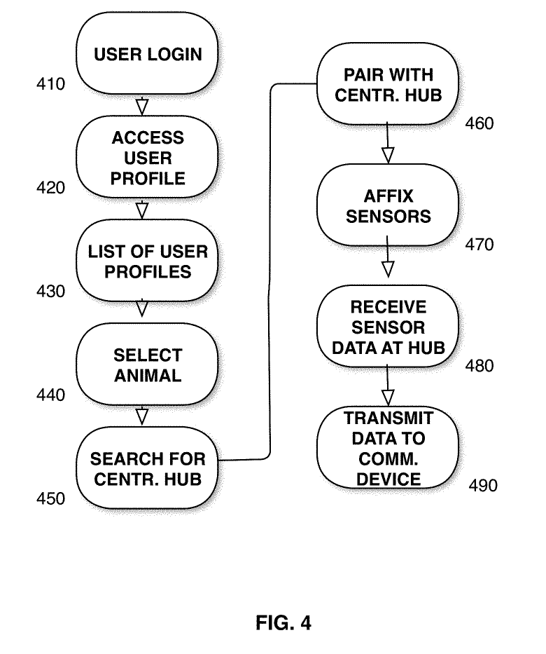

Referring to FIG. 4, a flow chart describing an exemplary mode of operation is shown.

Referring to step 410, a user may log in to the system using customized mobile application and unique credentials such as a user ID and password. A secure portal may be provided for a user to access a variety of system data and functions, and may include a selection of prior animals trained, and the ability to add a new animal to the profile.

At step 420, a user profile may be loaded, which profile includes information about user's name, date of birth and gender, among others. At step 430, for any authenticated user, a selection of animal subject profiles associated with the user may be loaded. Animal subject profiles include information about the animal's name, owner, date of birth and gender, among others. These animals may include animals that have been trained previously by the user, animals associated with a particular facility, or animals that have recently been assigned to this particular individual.

Once the subject animal has been selected by user at step 440 for training/data recording, the mobile computing device may (step 450) search for a centralized hub in range. A mobile computing device may be associated with a particular centralized hub on an ongoing basis. A centralized hub may be associated with a particular animal on an ongoing basis. Such a configuration provides for easy storage of the device with the other tack related to the animal. Alternatively, a centralized hub may be checked out on a session-by-session basis and returned for general usage following a training session.

The mobile computing device may then be paired with the centralized hub at step 460. In embodiments, mobile application software residing on the mobile application device may coordinate the pairing, possibly in conjunction with the mobile operating system. In embodiments, the user will be provided with confirmation that pairing has been successful.

At step 470, the various sensors are attached to the animal, and connected wirelessly or by wire to the centralized hub. Recording of data may then commence. During training, sensor data is received by the centralized hub (step 480) and then transmitted (step 490) by the centralized hub to the mobile computing device where it may be stored for future transmission to a remote location at operator's request and/or when a network connection is available. In alternative embodiments, mobile computing device may further transmit data on the fly to a remote server location. At the conclusion of recording session, data stored on the mobile computing device may be transmitted to a remote server location where analytics and reporting may be performed on the data.

In exemplary embodiments, the following features may be performed by the analytics and reporting system:

In embodiments, a web-based interface is provided for accessing the reporting and analytics system. A user may thus log in from a web browser or mobile device and access the features of the system. In embodiments, reporting and analytics functionality may be provided by mobile application residing on a user's mobile computing device. In alternative embodiments, data may be aggregated with other performance data into more complex database systems.

In embodiments, analysis functionality may be provided that provides analytics and performance metrics that display an animal's performance over time, as compared to other animals, and compares the performance to predetermine baselines and averages. Comparison may be based on animal's profile data such as age, race, gender or location.

In embodiments, reporting and analytics system may populate the database with performance data and biographical information about the animal with limited involvement by the user.

In embodiments, an analysis of raw data may be provided to calculate performance and health condition metrics. The raw data may be augmented by information added manually by the user such as feeling about training, mood of the animal, and other remarks or comments from the user.

In embodiments, reports and visual graphs may be generated from the performance data. Reports and visual graphs may be generated in response to specific user queries or according to a preset schedule. Various template report and graph formats may be provided.

In embodiments, reporting and analytics system may enable sharing of performance data to other users of the system of the present invention. Data may also be shared by conventional social media channels, or privately to a particular individual or group of individual such as the owner of an animal or the relatives of the owner of an animal.

While the foregoing system has been described in the exemplary context of an animal under training conditions, this context is for illustrative purposes only and not intended to be limiting. Indeed, the system of the present invention is applicable to virtually any living organism for which physiological metrics can be measured, and these additional applications are considered to be a part of the invention.

It will be understood that there are numerous modifications of the illustrated embodiments described above which will be readily apparent to one skilled in the art, such as increasing or and any other combinations of features disclosed herein that are individually disclosed or claimed herein, explicitly including additional combinations of such features. These modifications and/or combinations fall within the art to which this invention relates and are intended to be within the scope of the claims, which follow. It is noted, as is conventional, the use of a singular element in a claim is intended to cover one or more of such an element.

We claim:

1. A system for collecting data related to the physiology and performance of an animal comprising:
a plurality of sensors in contact with said animal;
a hub in communication with said plurality of sensors, wherein said hub is configured to communicate data from said plurality of sensors to a local communication device; and
wherein said data is stored and analyzed on said local communication device or sent to a remote server for analysis.

2. The system of claim 1 wherein said hub comprises a wireless transceiver, enclosure, processor, memory, and battery.

3. The system of claim 1 wherein said hub further comprises a unique identifier.

4. The system of claim 1 wherein said hub is wirelessly connected to said local communication device and at least one of said sensors.

5. The system of claim 1 wherein said plurality of sensors measure at least one of heart rate, speed, and respiratory rate.

6. The system of claim 1 wherein said local communication device is a smartphone.

7. The system of claim 1 wherein said local communication device capable of performing real-time analysis and reporting of data.

8. The system of claim 1 wherein said hub is encased in a protective enclosure that renders it substantially impervious to dirt and moisture.

9. The system of claim 1 wherein at least one of said plurality of sensors are affixed to the skin of the animal.

10. The system of claim 1 wherein at least one of said plurality of sensors are attached to the animal using a horsebit.

11. The system of claim 1 wherein at least one of said plurality of sensors are inserted into the ear canal of the animal.

12. The system of claim 1 further comprising application software loaded on said local communication device that enables said local communication device to pair with said hub, receive said data, and perform analytics on said data.

13. A method for evaluating the physiology and performance of an animal comprising:
attaching a plurality of sensors to said animal;
connecting said sensors to a hub comprising a wireless transceiver, enclosure, processor, memory, and battery, wherein said hub is configured to communicate data from said plurality of sensors to a local communication device;
initiating application software loaded on said local communication device that enables said local communication device to pair with said hub, receive said data, and perform analytics on said data; and
receiving and storing data from said animal.

14. The method of claim 13 further comprising the step of using said local communication device to transmit a unique identifier associated with said hub to a remote server for authentication.

15. The method of claim 13 further comprising using position data calculated by local communication device to determine that a training regimen has ended.

16. The method of claim 13 further comprising using one of said sensors to determine whether an asymmetry exists in the animal's stride and gait.

17. The method of claim 13 further comprising using a saliva-based sensor to measure lactic acid production in the animal.

18. The method of claim 13 further comprising placing a microphone in an ear of said animal to monitor the respiratory rate of the animal.

19. The method of claim 13 wherein at least one of said plurality of sensors are affixed to the skin of the animal.

20. The method of claim 13 wherein at said application software provides a visual representation of the animal's performance or health condition.

21. A system for collecting data related to the physiology and performance of an animal comprising:
means for a reading physiological indicators data from an animal;
means for receiving said data transmitting it to a local communication device; and
means for analyzing, storing, and recalling said data.
